(19) United States
(12) Patent Application Publication
(10) Pub. No.: US 2019/0016853 A1
(43) Pub. Date: Jan. 17, 2019

(54) COMPOSITIONS CONTAINING POLYMERIC CARBODIIMIDE, EPOXIDE AND POLYESTER-BASED POLYMERS, THEIR PRODUCTION AND USE

(71) Applicant: LANXESS Deutschland GmbH, Cologne (DE)

(72) Inventors: Boris NEUWALD, Cologne (DE); Matthias BIENMULLER, Krefeld (DE); Wilhelm LAUFER, Ellerstadt (DE)

(73) Assignee: LANXESS Deutschland GmbH, Cologne (DE)

(21) Appl. No.: 16/027,695

(22) Filed: Jul. 5, 2018

(30) Foreign Application Priority Data
Jul. 17, 2017 (EP) 17181680.4

(51) Int. Cl. C08G 63/08; C08G 63/183; C08G 73/00; C08G 59/06

(52) U.S. Cl. CPC C08G 63/08; C08G 63/183; C08G 2120/00; C08G 59/063; C08G 73/00

(57) ABSTRACT

The present invention relates to compositions containing polymeric carbodiimide, epoxide and polyester-based polymers, their production and use.

The present invention relates to compositions containing polymeric carbodiimide, epoxide and polyester-based polymers, their production and use for hydrolysis inhibition.

### BACKGROUND INFORMATION

A very wide variety of carbodiimides have proven advantageous in many applications, for example as hydrolysis inhibitors for thermoplastics, ester-based polyols, polyurethanes, triglycerides and lubricating oils etc. However, they have the disadvantage of emitting gases possibly harmful to health and are very costly and complex to produce.

Epoxides are cheaper to produce but have the disadvantage that they do not attain the hydrolysis-stabilizing activity of carbodiimides even in very high concentrations. They act merely as acid scavengers and provide only inadequate long-term stabilization at higher temperatures. Particularly in very demanding applications under conditions such as high atmospheric humidity and temperature they fail in their activity as hydrolysis inhibitors since ester-based plastics are generally processed at temperatures above 200° C. DE 10349168 A1 describes a hydrolysis inhibitor composed of epoxidized fatty acid esters and glycerides and a mixture thereof with a monomeric carbodiimide. The stabilizers described therein act as acid scavengers in oils. However, under the abovementioned conditions in the processing of ester-based thermoplastics they show inadequate, if any, activity for long-term stability to hydrolysis. Moreover, the use of monomeric carbodiimides results in increased emissions of toxic gases.

The present invention accordingly has for its object to provide novel, cost-effective compositions which are hydrolysis-resistant, cost-effective to produce and show reduced emissions.

### SUMMARY OF THE INVENTION

It is now been found that, surprisingly, that the abovementioned object may be achieved when a combination of at least one polymeric aromatic carbodiimide, at least one epoxide having at least 2 epoxide groups and at least one polyester-based polymer, in particular a polyalkylene terephthalate or polylactide, is employed.

### DESCRIPTION OF EMBODIMENTS

The present invention accordingly provides compositions containing

(a) at least one polymeric aromatic carbodiimide of formula (I)

R¹—R²—(—N═C═N—R²—)ₘ—R¹ (I),
in which
m represents an integer from 2 to 500, preferably 3 to 20, very particularly preferably 4 to 10,
R² represents C₁-C₁₂-alkyl-substituted arylenes, C₇-C₁₈-alkylaryl-substituted arylenes and optionally C₁-C₁₂-alkyl-substituted C₁-C₈-alkylene-bridged arylenes comprising a total of 7 to 30 carbon atoms and arylene, preferably

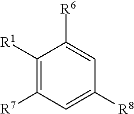

R⁶, R⁷ and R⁸ each independently represent methyl or ethyl, wherein each benzene ring bears only one methyl group and n=1 to 10
and
R¹ is —NCO, —NCNR³—NHCONHR³, —NHCONR³R⁴ or —NHCOOR⁵,
wherein R³ and R⁴ are identical or different and represent a C₁-C₁₂-alkyl, C₆-C₁₂-cycloalkyl, C₇-C₁₈-aralkyl or aryl radical and R⁵ represents a C₁-C₂₂-alkyl-, C₆-C₁₂-cycloalkyl-, C₆-C₁₈-aryl or C₇-C₁₈-aralkyl radical and an unsaturated alkyl radical having 2-22 carbon atoms or an alkoxypolyoxyalkylene radical ,
(b) at least one epoxide, preferably having at least 2 epoxide groups, and
(c) at least one thermoplastic polyester-based polymer.

The term arylene comprises in particular phenylene, naphthalene, anthrylene and/or phenanthrylene radicals, preferably phenylene radicals.

The polymeric aromatic carbodiimides a) are preferably compounds of formula (II),

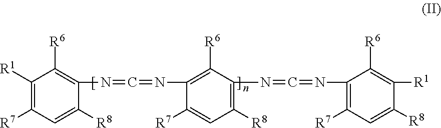

where R¹ is selected from the group —NCO, —NHCONHR³, —NHCONR³R⁴ or

—NHCOOR⁵,

wherein R³ and R⁴ are identical or different and represent a C₁-C₁₂-alkyl, C₆-C₁₂-cycloalkyl, C₇-C₁₈-Aralkyl radical or aryl radical,

R⁵ represents a C₁-C₂₂-alkyl-, C₆-C₁₂-cycloalkyl-, C₆-C₁₈-aryl or C₇-C₁₈-aralkyl radical and an unsaturated alkyl radical having 2-22 carbon atoms, preferably 12-20, particularly preferably 16-18 carbon atoms, or an alkoxypolyoxyalkylene radical and

R⁶, R⁷ and R⁸ each independently represent methyl or ethyl, wherein each benzene ring bears only one methyl group and n=1 to 10.

The carbodiimide content (NCN content measured by titration with oxalic acid) of the carbodiimides of formula (II) employed according to the invention is preferably 2-14% by weight, preferably 4-13% by weight, particularly preferably 6-12% by weight.

Furthermore, the carbodiimides employed according to the invention preferably have average molar masses (Mw) of 1000-5000 g/mol, preferably 1500-4000 g/mol, particularly preferably 2000-3000 g/mol, determined by GPC viscometry.

Furthermore, preference is given to carbodiimides of formula (II) having a polydispersity D=Mw/Mn of 1.2-2.2, particularly preferably 1.4-1.8.

The carbodiimides are preferably commercially available compounds such as for example the polymeric carbodiimides named Stabaxol® from Lanxess Deutschland GmbH. However, they may also be produced for example by the processes described in EP14191710.4.

It is preferable when the component b) comprises altogether at least two epoxide groups per molecule, wherein preferably at least one epoxide group is terminal.

The production of epoxidized compounds is likewise known to those skilled in the art. Preferred epoxidized compounds are polyglycidyl or poly(beta-methylglycidyl) ethers, preferably obtainable by reaction of a compound having at least two free alcoholic or phenolic hydroxyl groups and/or by reaction of phenolic hydroxyl groups with a substituted epichlorohydrin.

Preferred polyglycidyl or poly(beta-methylglycidyl) ethers derive from acyclic alcohols, in particular ethylene glycol, diethylene glycol and higher poly(oxyethylene) glycols, propane-1,2-diol or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylpropane, bistrimethylolpropane, pentaerythritol, sorbitol, or from polyepichlorohydrins.

Alternatively preferred polyglycidyl or poly(beta-methylglycidyl) ethers derive from cycloaliphatic alcohols, in particular 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or they comprise aromatic nuclei based on N,N-bis(-8, 2-hydroxyethyl)aniline or p,p′-bis(2-hydroxyethylamino)diphenylmethane.

Preferred epoxidized compounds are also based on mononuclear phenols, on polynuclear phenols.

Preferred mononuclear phenols are resorcinol or hydroquinone.

Preferred polynuclear phenols are bis(4-hydroxyphenyl)methane, 2,2-bis(4-hydroxyphenyl)propane, 2,2-bis(3,5-dibromo-4-hydroxyphenyl)propane or 4,4′-dihydroxydiphenylsulphone.

Preferred condensation products of phenols with formaldehyde are phenol novolacs.

Preferred aromatic epoxide compounds have 2 terminal epoxide functions.

A preferred aromatic epoxide compound having 2 terminal epoxide functions is an oligomeric reaction product of bisphenol A with epichlorohydrin having an average molecular weight according to EN ISO 10927 in the range from 900 to 1200 g/mol and an epoxy index (according to ISO 3001) in the range from 450 to 600 grams per equivalent. It is particularly preferable when component c) is an oligomeric reaction product of bisphenol A with epichlorohydrin of formula (III)

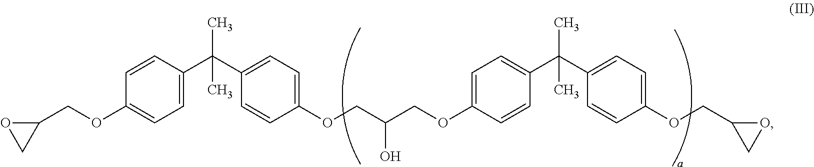

where a is 0 to 10, preferably where a is 1 to 8, particularly preferably where a is 1 to 6, particularly preferably in the range from 2 to 3, wherein a represents the average number.

The components c) are preferably produced by a process according to US2002/0128428 A1 and then have an average molecular weight according to EN ISO 10927 in the range from 900 to 1200 g/mol (corresponds in formula (III) to an a in the range from 2 to 3) and an epoxy index (according to ISO 3001) in the range from 450 to 600 grams per equivalent.

An epoxide compound employable according to the invention preferably has a Mettler softening point according to DIN 51920 in the range from 0 to 150° C., particularly preferably 50° C. to 120° C., very particularly preferably in the range from 60° C. to 110° C. and in particular in the range from 75° C. to 95° C. The Mettler softening point is the temperature at which the sample flows out of a cylindrical nipple having an outflow opening of 6.35 mm in diameter, thus interrupting a light gate which lies 19 mm below. To this end, the sample is heated in air under constant conditions.

Preferably employable epoxide compounds have an average epoxide equivalent weight (EEW, grams of resin containing one mole of epoxidically bonded oxygen) via titration according to DIN 16945 in the range from 162 to 2000 g/eq, preferably in the range from 250 to 1200 g/eq, particularly preferably in the range from 350 to 1000 g/eq and especially preferably in the range from 450 bis 800 g/eq.

Especially preferably employed as component b) is a poly(bisphenol A-co-epichlorohydrin) [CAS No. 25068-38-6] preferably having a number average molecular weight (Mₙ) determined by MALDI-TOF mass spectrometry by matrix-assisted laser desorption/ionization time-of-flight mass spectrometry according to EN ISO 10927 in the range from 600 to 1800 g/mol, obtainable for example as Epilox® from Leuna Harze GmbH, Leuna.

Further preferred epoxide compound having at least 2 epoxide functions are compounds from the series of epoxides commercially available under the name Joncryl® from BASF AG, for example Joncryl® 4368, which contain the following units in any combination

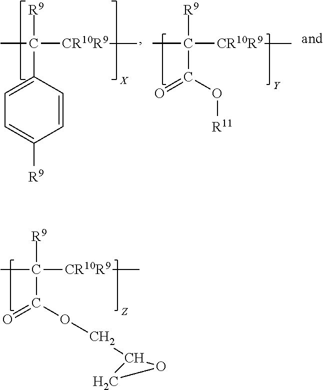

where R⁹, R¹⁰=independently of one another H, C₁₋C₈-alkyl, R¹¹=independently of one another C₁-C₈-alkyl, x, y=1-20, z=2-20, wherein end groups R. represent H, C₁-C₈-alkyl.

The epoxide preferably conforms to formula (IV)

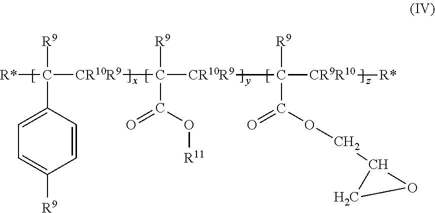

where R⁹, R¹⁰=independently of one another H, C₁₋C₈-alkyl, R¹¹=independently of one another C₁-C₈-alkyl, x, y=1-20, z=2-20, wherein end groups R. represent H, C₁-C₈-alkyl.

The thermoplastic polyester-based polymers c) are preferably poly-C₁-C₈-alkyl terephthalates, particularly preferably polyethylene terephthalate (PET), polytrimethylene terephthalate (PTT), and copolyesters, thermoplastic polyester elastomers (TPE E), ethylene vinyl acetate (EVA), polylactic acid (PLA) and/or PLA derivatives, polybutylene succinates (PBS), polyhydroxyalkanoates (PHA) and various blends thereof.

Polylactides (PLA) are very particularly preferred.

In a preferred embodiment of the present invention the composition according to the invention contains
a) 0.2% to 2% by weight, preferably 0.4% to 1.5% by weight, particularly preferably 0.5% to 1.0% by weight;
b) 0.05% to 4% by weight, preferably 0.1% to 2% by weight, particularly preferably 0.5% to 1.5% by weight;
c) 94% to 99.75% by weight, preferably 96.5 to 99.5% by weight, particularly preferably 97.5 to 99.0% by weight.

In a further preferred embodiment of the present invention the compositions contain no additional components other than the components a), b) and c), wherein the sum of the proportions of a), b) and c) is 100% by weight.

The present invention further provides a process for producing a composition according to which the components a) and b) are admixed into at least one thermoplastic polyester-based polymer c). Preference is given here to extruders or kneaders, particularly preferably extruders. These are commercially available stirring and mixing assemblies.

In one preferred embodiment of the present invention the admixing of the components a), b) and c) is effected at temperatures of 150° C. to 300° C.

In a further embodiment of the process according to the invention further additives, preferably nucleating agents, fibres for reinforcing, impact modifiers, flow enhancers and/or UV stabilizers are admixed into the mixture of the components a), b) and c).

The present invention further relates to a process for producing hydrolysis-stable articles of manufacture by processing compositions containing the components a), b) and c) in at least one mixing assembly, preferably a compounder, into moulding materials and subjecting these to further processing, preferably an injection moulding process or an extrusion, to produce articles of manufacture.

Processes according to the invention for producing articles of manufacture by extrusion or injection moulding are performed at melt temperatures in the range from 160 to 330° C., preferably in the range from 190 to 300° C., and optionally also at pressures of not more than 2500 bar, preferably at pressures of not more than 2000 bar, particularly preferably at pressures of not more than 1500 bar and very particularly preferably at pressures of not more than 750 bar.

In extrusion it is preferable to distinguish between profile extrusion and sequential coextrusion. Sequential coextrusion involves extruding two different materials successively in alternating sequence. In this way, a preform having a different material composition section by section in the extrusion direction is formed. It is possible to provide particular article sections with specifically required properties through appropriate material selection, for example for articles with soft ends and a hard middle section or integrated soft bellow regions (Thielen, Hartwig, Gust, “Blasformen von Kunststoffhohlkörpern” [Blow-Moulding of Hollow Plastics Bodies], Carl Hanser Verlag, Munich 2006, pages 127-129).

The process of injection moulding comprises melting (plasticization) the raw material, preferably in pellet form, in a heated cylindrical cavity, and injection thereof as an injection moulding material under pressure into a temperature-controlled cavity. Employed as raw material are compositions according to the invention which have preferably already been processed into a moulding material by compounding, where said moulding material has in turn preferably been processed into a pellet material. After cooling (solidification) of the moulding material injected into the temperature-controlled cavity the injection-moulded part is demoulded.

In contrast to injection moulding, in extrusion an endless plastics extrudate of a moulding compound according to the invention is employed in an extruder, wherein the extruder is a machine for producing thermoplastic mouldings/articles of manufacture. Employable apparatuses include
single-screw extruders and twin-screw extruders and the respective sub-groups
conventional single-screw extruders, conveying single-screw extruders,
contra-rotating twin-screw extruders and co-rotating twin-screw extruders.

Extrusion plants preferably consist of the elements extruder, mould, downstream equipment, extrusion blow moulds. Extrusion plants for producing profiles preferably consist of the elements: extruder, profile mould, calibrating unit, cooling zone, caterpillar take-off and roller take-off, separating device and tilting chute. Extrusion plants for producing films consist of the elements: extruder, cooling zone, stretching and roller take-off.

Articles of manufacture obtainable according to the invention are preferably materials exposed to aqueous media, atmospheric humidity or water spray.

Such hydrolysis-stabilized articles of manufacture may be found in motor vehicles, in the electronics, telecommunication, information technology or computer industries and also in the household, sports, medical or entertainment sectors. In a preferred variant the compositions according to the invention are used for producing hydrolysis-stable films, for example for packaging or solar cells.

The present invention further provides for the use of the composition according to the invention for producing articles of manufacture by extrusion, preferably for packaging or solar cells.

The purview of the invention encompasses all hereinabove and hereinbelow recited general or preferred definitions of radicals, indices, parameters and elucidations among themselves, i.e. including between the respective ranges and preferences in any combination.

The examples which follow serve to elucidate the invention but have no limiting effect.

### EXAMPLES

Materials employed:
1) Stab A: a monomeric carbodiimide having an NCN content of about 10.8% by weight based on 2,6-diisopropylphenyl isocyanate, obtainable from Lanxess Deutschland GmbH under the name Stabaxol® I.
2) Stab B: a polymeric carbodiimide having an NCN content of about 11.8% by weight, D=about 1.8 and Mw=2300 g/mol of formula (II) where n=about 3-4, R⁶, R⁷, R⁸ each independently represent methyl or ethyl, wherein each benzene ring bears only one methyl group and R¹═—NHCOOR⁵ and R⁵=cyclohexyl.
3) Stab C: And epoxide of formula (III) where n=in the range from 2-3 with an epoxide equivalent weight (DIN 16945) of 500 to 700 g/eq and a softening point (Mettler, DIN 51920) between 75 and 90° C. [CAS Nr. 25068-38-6].
4) Polyethylene terephthalate (PET) obtainable from Novapet.
5) Polylactic acid (PLA) obtainable from NatureWorks.

Hydrolysis Inhibition in Polyethylene Terephthalate (PET)

To evaluate the hydrolysis-inhibiting effect in PET the stabilizers employed according to the example (Stab A, B and C) were dispersed into PET by means of a ZSK 25 laboratory twin screw extruder from Werner & Pfleiderer before the measurement in PET at about 280° C. described below. F3 standard test specimens used for measuring tensile strength were then prepared from the obtained pellet materials on an Arburg Allrounder 320 S 150-500 injection moulding machine.

For the hydrolysis test, these F3 standard test specimens were stored in water vapour at a temperature of 110° C. and the tensile strength thereof measured in MPa.

Hydrolysis Inhibition in Polylactic Acid (PLA)

To evaluate the hydrolysis-inhibiting effect in PLA the stabilizers employed according to the example (Stab B and C) were dispersed into PLA by means of a ZSK 25 laboratory twin screw extruder from Werner & Pfleiderer before the measurement in PLA at about 200° C. described below. F3 standard test specimens used for measuring tensile strength were then prepared from the obtained pellet materials on an Arburg Allrounder 320 S 150-500 injection moulding machine.

For the hydrolysis test, these F3 standard test specimens were stored in water at a temperature of 65° C. and the tensile strength thereof measured in MPa.

The use amounts of the mixture constituents and the results are listed in tables 1 and 2:

TABLE 1

| | | | | | | Ex. 5 |
|---|---|---|---|---|---|---|
| Relative | | | Ex. 2 | Ex. 3 | Ex. 4 | (comp.) |
| tensile | | Ex. 1 | (comp.) | (comp.) | (comp.) | PET, |
| strength | | (comp.) | PET, | PET, | PET, | 1% Stab A, |
| (%) | | PET | 1% Stab A | 2% Stab C | 4% Stab C | 1.5% Stab C |
| 0 | days | .100 | 100 | 100 | 100 | 100 |
| 1 | day | 75 | 86 | 61 | 63 | 86 |
| 2 | days | 40 | 80 | 33 | 40 | 81 |
| 3 | days | 0 | 64 | 0 | 0 | 65 |
| 4 | days | | 44 | | | 47 |
| 5 | days | | 30 | | | 38 |

comp. = comparative example from DE 10349168,
inv. = inventive

TABLE 2

| Relative | | | | Ex. 7 (inv.) |
|---|---|---|---|---|
| tensile strength | | Ex. 1 (comp.) | Ex. 6 (comp.) | PET, 1% Stab B, |
| (%) | | PET | PET, 1% Stab. B | 1.5% Stab. C |
| 0 | days | 100 | 100 | 100 |
| 1 | day | 75 | 86 | 89 |
| 2 | days | 40 | 83 | 89 |
| 3 | days | 0 | 76 | 87 |
| 4 | days | | 60 | 82 |
| 5 | days | | 40 | 64 |
| 6 | days | | 18 | 54 |
| 7 | days | | 0 | 40 |

comp. = comparative example,
inv. = inventive

TABLE 3

| Relative | | | | | Ex. 11 |
|---|---|---|---|---|---|
| tensile | | | Ex. 9 | Ex. 10 | (inv.) PLA, |
| strength | | Ex. 8 | (comp.) PLA, | (comp.) PLA, | 0.5% Stab B, |
| (%) | | (comp.) PLA | 4% Stab C | 0.5% Stab B | 1.5% Stab C |
| 0 | days | 100 | 100 | 100 | 100 |
| 1 | day | 94 | 96 | 98 | 98 |
| 2 | days | 62 | 79 | 96 | 97 |
| 3 | days | 22 | 57 | 71 | 97 |
| 4 | days | 0 | 0 | 44 | 97 |
| 5 | days | | | 0 | 97 |
| 6 | days | | | | 97 |
| 7 | days | | | | 97 |
| 8 | days | | | | 97 |
| 9 | days | | | | 97 |
| 10 | days | | | | 97 |
| 11 | days | | | | 94 |
| 12 | days | | | | 88 |
| 13 | days | | | | 67 |
| 14 | days | | | | 53 |
| 15 | days | | | | 28 |
| 16 | days | | | | 0 |

comp. = comparative example from DE 10349168,
inv. = inventive

The reported percentages in tables 1 and 2 are the % by weight proportions of the corresponding stabilizers.

The results of the hydrolysis inhibition tests demonstrate that the epoxides alone show little if any stabilizing effect but, surprisingly, together with the polymeric carbodiimides according to the invention (for example Stab. B) show a clear positive synergistic effect on hydrolysis stability. By contrast the combination of monomeric carbodiimides with the epoxides does not result in such a synergistic effect.

What is claimed is:

1. A composition comprising:
(a) at least one polymeric aromatic carbodiimide of formula (I)
R¹—R²—(—N═C═N—R²—)ₘ—R¹ (I),
in which
m represents an integer from 2 to 500, preferably 3 to 20, very particularly preferably 4 to 10;
R²═C₁-C₁₂-alkyl-substituted arylenes, C₇-C₁₈-alkylaryl-substituted arylenes and optionally C₁-C₁₂-alkyl-substituted alkylene-bridged arylenes comprising a total of 7 to 30 carbon atoms and arylene; and
R¹═—NCO, —NCNR³, —NHCONHR³, —NHCONR³R⁴ or —NHCOOR⁵, wherein R³ and R⁴ are identical or different and represent a C₁-C₁₂-alkyl, C₆-C₁₂-cycloalkyl, C₇-C₁₈-aralkyl or aryl radical and R⁵ represents a C₁-C₂₂-alkyl-, C₆-C₁₂-cycloalkyl-, C₆-C₁₈-aryl or C₇-C₁₈-aralkyl radical and an unsaturated alkyl radical having 2-22 carbon atoms or an alkoxypolyoxyalkylene radical;
(b) at least one epoxide; and
(c) at least one thermoplastic polyester-based polymer selected from the group comprising polyethylene terephthalate (PET), polytrimethylene terephthalate (PTT), thermoplastic polyester elastomers (TPE E), ethylene vinyl acetate (EVA), polylactic acid (PLA) and/or PLA derivatives, polybutylene succinates (PBS), polyhydroxyalkanoates (PHA), and various blends, thermoplastic polyurethanes, polyurethane elastomers, PU adhesives, and PU casting resins.

2. The composition according to claim 1, wherein the polymeric aromatic carbodiimides are compounds of formula (II) 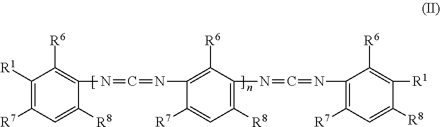
where:
R¹ is selected from the group —NCO, —NHCONHR³, —NHCONR³R⁴ or —NHCOOR⁵, and R³ and R⁴ are identical or different and represent a C₁-C₁₂-alkyl, C₆-C₁₂-cycloalkyl, C₇-C₁₈-aralkyl radical or aryl radical;
R⁵ represents a C₁-C₂₂-alkyl-, C₆-C₁₂-cycloalkyl-, C₆-C₁₈-aryl or C₇-C₁₈-aralkyl radical and an unsaturated alkyl radical having 2-22 carbon atoms, preferably 12-20, particularly preferably 16-18 carbon atoms, or an alkoxypolyoxyalkylene radical; and
R⁶, R⁷ and R⁸ each independently represent methyl or ethyl, wherein each benzene ring bears only one methyl group and n=1 to 10.

3. The composition according to claim 2, wherein R⁵ represents a C₁-C₂₂-alkyl-, C₆-C₁₂-cycloalkyl-, C₆-C₁₈-aryl or C₇-C₁₈-aralkyl radical and an unsaturated alkyl radical having 16-18 carbon atoms, or an alkoxypolyoxyalkylene radical.

4. The composition according to claim 1, wherein the epoxide is an epoxide having at least 2 epoxide groups.

5. The composition according to claim 4, wherein the epoxide is an oligomeric reaction product of bisphenol A with epichlorohydrin having an average molecular weight, according to EN ISO 10927, of 900 to 1200g/mol and an epoxy index, according to ISO 3001, of 450 to 600 grams per equivalent.

6. The composition according to claim 4, wherein the epoxide is an oligomeric reaction product of bisphenol A with epichlorohydrin of formula (III), 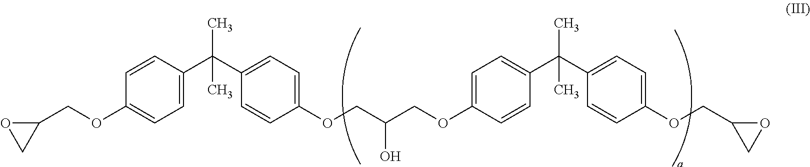
where a is 0 to 10, preferably where a is 1 to 8, particularly preferably where a is 1 to 6, very particularly preferably in the range from 2 to 3, wherein a represents the average number -.

7. The composition according to claim 6, wherein the epoxide is an oligomeric reaction product of the bisphenol A with the epichlorohydrin where a is 1 to 6, very particularly preferably in the range from 2 to 3.

8. The composition according to claim 4, wherein the epoxide is a compound containing the units 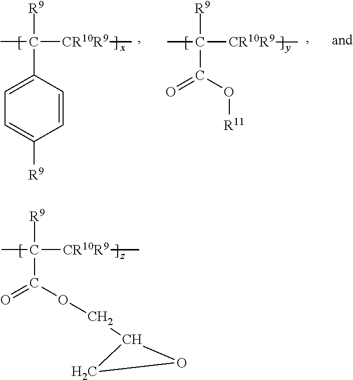
where R⁹, R¹⁰=independently of one another H, C₁₋C₈-alkyl, R¹¹=independently of one another C₁-C₈-alkyl, x, y=1-20, z=2-20, wherein end groups R. are H, C₁-C₈-alkyl, in any sequence.

9. The composition according to claim 4, wherein the epoxide is a compound of formula (IV) 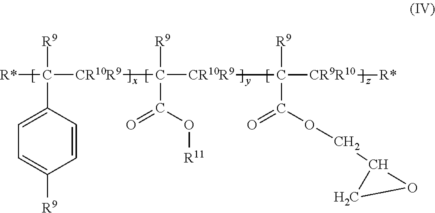
where: R⁹, R¹⁰═H, C₁₋C₈-alkyl, R¹⁰ is C₁₋C₈-alkyl, x, y=1-20 and z=2-20, and R.═H, C₁₋C₈-alkyl.

10. The composition according to claim 1, wherein the composition comprises components a), b) and c) in the following proportions:
a) 0.2-2% by weight,
b) 0.05-4% by weight, and
c) 94-99.75% by weight.

11. The composition according to claim 1, wherein the composition comprises components a), b) and c) in the following proportions:
a) 0.4-1.5% by weight,
b) 0.1-2% by weight, and
c) 96.5-99.5% by weight.

12. The composition according to claim 1, wherein:
the polymeric aromatic carbodiimides are compounds of formula (II) 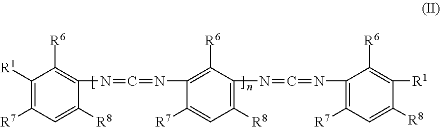
where:
R¹ is selected from the group —NCO, —NHCONHR³, —NHCONR³R⁴ or —NHCOOR⁵, and R³ and R⁴ are identical or different and represent a C₁-C₁₂-alkyl, C₆-C₁₂-cycloalkyl, C₇-C₁₈-aralkyl radical or aryl radical;
R⁵ represents a C₁-C₂₂-alkyl-, C₆-C₁₂-cycloalkyl-, C₆-C₁₈-aryl or C₇-C₁₈-aralkyl radical and an unsaturated alkyl radical having 2-22 carbon atoms, or an alkoxypolyoxyalkylene radical; and
R⁶, R⁷ and R⁸ each independently represent methyl or ethyl, wherein each benzene ring bears only one methyl group and n=1 to 10;
the epoxide is an oligomeric reaction product of bisphenol A with epichlorohydrin having an average molecular weight, according to EN ISO 10927, of 900 to 1200g/mol and an epoxy index, according to ISO 3001, of 450 to 600 grams per equivalent; and
the composition comprises components a), b) and c) in the following proportions:
a) 0.2-2% by weight,
b) 0.05-4% by weight, and
c) 94-99.75% by weight.

13. The composition according to claim 1, wherein:
the polymeric aromatic carbodiimides are compounds of formula (II) 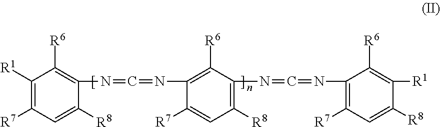
where:
R¹ is selected from the group —NCO, —NHCONHR³, —NHCONR³R⁴ or 13 NHCOOR⁵, and R³ and R⁴ are identical or different and represent a C₁-C₁₂-alkyl, C₆-C₁₂-cycloalkyl, C₇-C₁₈-aralkyl radical or aryl radical;
R⁵ represents a C₁-C₂₂-alkyl-, C₆-C₁₂-cycloalkyl-, C₆-C₁₈-aryl or C₇-C₁₈-aralkyl radical and an unsaturated alkyl radical having 2-22 carbon atoms, or an alkoxypolyoxyalkylene radical; and
R⁶, R⁷ and R⁸ each independently represent methyl or ethyl, wherein each benzene ring bears only one methyl group and n=1 to 10;
the epoxide is a compound of formula (IV) 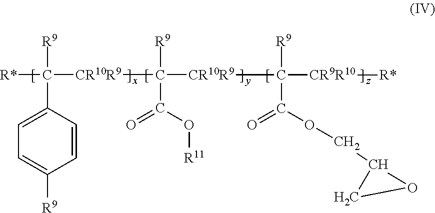
where: R⁹, R¹⁰═H, C₁₋C₈-alkyl, R¹⁰ is C₁₋C₈-alkyl, x, y=1-20 and z=2-20, and R.═H, C₁₋C₈-alkyl; and
the composition comprises components a), b) and c) in the following proportions:
a) 0.5-1.0% by weight,
b) 0.5-1.5% by weight, and
c) 97.5-99.0% by weight.

14. A process for producing the composition according to claims 1, the process comprising admizing the components a) and b) into the at least one thermoplastic polyester-based polymer c).

15. The process according to claim 14, wherein the components a) and b) are admixed into the at least one thermoplastic polyester-based polymer c) at a temperatures of 160-330° C., in the following proportions:
a) 0.2-2% by weight,
b) 0.05-4% by weight, and
c) 94-99.75% by weight.

16. The process according to claim 15, wherein:
the polymeric aromatic carbodiimides are compounds of formula (II) 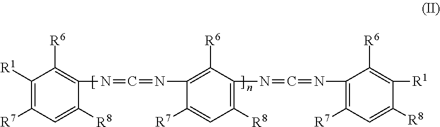
where:
R¹ is selected from the group —NCO, —NHCONHR³, —NHCONR³R⁴ or —NHCOOR⁵, and R³ and R⁴ are identical or different and represent a C₁-C₁₂-alkyl, C₆-C₁₂-cycloalkyl, C₇-C₁₈-aralkyl radical or aryl radical;
R⁵ represents a C₁-C₂₂-alkyl-, C₆-C₁₂-cycloalkyl-, C₆-C₁₈-aryl or C₇-C₁₈-aralkyl radical and an unsaturated alkyl radical having 2-22 carbon atoms, or an alkoxypolyoxyalkylene radical; and
R⁶, R⁷ and R⁸ each independently represent methyl or ethyl, wherein each benzene ring bears only one methyl group and n=1 to 10;
the epoxide is a compound of formula (IV) 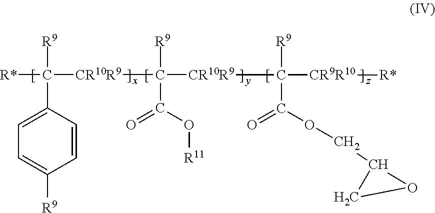
where: R⁹, R¹⁰═H, C₁₋C₈-alkyl, R¹⁰ is C₁₋C₈-alkyl, x, y=1-20 and z=2-20, and R.═H, C₁₋C₈-alkyl; and
the components a) and b) are admixed into the at least one thermoplastic polyester-based polymer in the following proportions:
a) 0.5-1.0% by weight,
b) 0.5-1.5% by weight, and
c) 97.5-99.0% by weight.

17. Articles of manufacture obtained by admixing the composition according to claim 1 in at least one mixing assembly, and further processing of the mixture to afford moulding the articles in injection moulding processes or by means of extrusion.

18. The articles of manufacture according to claim 17, wherein the articles are hydrolysis-stable articles of manufacture, and the components are admixed in a compounder.

19. The articles of manufacture according to claim 18, wherein the articles are produced by extrusion of the composition, and comprise packaging or solar cells.
